(19) United States
(12) Patent Application Publication
(10) Pub. No.: US 2012/0232880 A1
(43) Pub. Date: Sep. 13, 2012

(54) PERFORMANCE ASSESSMENT OF A PROGRAM MODEL

(75) Inventor: Gad Haber, Nesher (IL)

(73) Assignee: International Business Machines Corporation, Armonk, NY (US)

(21) Appl. No.: 13/046,747

(22) Filed: Mar. 13, 2011

(51) Int. Cl. G06F 9/45

(52) U.S. Cl. 703/22

(57) ABSTRACT

An apparatus and a computer-implemented method performed by a computerized device comprising: receiving a model describing an aspect of a computer program; and determining comparative performance assessment of a property of the model by operating the model.

### TECHNICAL FIELD

The present disclosure relates to program modeling in general, and to analyzing the performance of a program model, in particular.

### BACKGROUND

Computerized devices and computer programs control almost every aspect of our life, from writing documents to controlling traffic lights through commerce, communication, industry and almost any other area. Many of these computer programs are of high complexity, and may be created by a multiplicity of people over a long period of time.

Creating a non-trivial computer program usually involves one or more design stages, and one or more implementation stages, sometimes referred to as coding stages.

Some developers develop the program in a Model-Driven methodology, using a modeling language. During the design stages, one or more models of the program, which may be implemented for example in Universal Modeling Language (UML), may be generated. Such models can be generated using dedicated tools, which may be embedded in any integrated modeling environment (IDE), such as Rational© Rhapsody™. Typically, a more detailed design provides for a program of higher quality and a better product.

The models can refer to any aspect of the program, and may include object diagrams, state diagrams, or other diagrams. An object diagram may comprise modeled representations of real objects, parts, components, or the like, optionally relations between objects, such as links, associations, containment, or the like, and optionally members and methods of each object. State diagrams may comprise states at which the program can be, and transitions between such states.

Current design technologies do not enable full testing of all aspects of the model, so that design bugs, performance issues and other problems may not be found until an actual program is coded, at which stage much effort had already been put in, and significant resources may be required for fixing the problems, including going back to the design stages followed by re-programming

### BRIEF SUMMARY

One exemplary embodiment of the disclosed subject matter is a computer-implemented method performed by a computerized device, comprising: receiving a model describing an aspect of a computer program; and operating the model, and determining comparative performance assessment of a property of the model.

Another exemplary embodiment of the disclosed subject matter is n apparatus having a processing unit and a storage device, the apparatus comprising: a computer program receiver configured to obtain a model describing an aspect of a computer program; and an animation component for operating the model, and determining comparative performance assessment of a property of the model.

Yet another exemplary embodiment of the disclosed subject matter is a computer program product comprising: a non-transitory computer readable medium; a first program instruction for receiving a model describing an aspect of a computer program; and a second program instruction for operating the model, and determining comparative performance assessment of a property of the model, wherein said first and second program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a simplified illustration of exemplary performance data as provided by some exemplary embodiments of the subject matter;

FIG. 2 shows another simplified illustration of exemplary performance data as provided by some exemplary embodiments of the subject matter;

FIG. 3 shows a flowchart diagram of steps in a method for assessing performance of a model, in accordance with some exemplary embodiments of the disclosed subject matter; and

FIG. 4 shows a block diagram of components of an apparatus for assessing performance of a model, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is the lack of ability to measure or assess performance parameters of one or more aspects of a program at design time, before significant effort is put into actually coding the program. Thus, even initial profiling and tracing can only be performed once the program is available, after much work has already been done. Even further, some design bugs can only be revealed after coding the program, at which time fixing the design also means having to re-program at least parts of the code.

Some performance parameters are comparative in nature. For example, it may be important to understand which operations, or which objects in object-oriented design are invoked more frequently or consume heavier resources, such as processing time, than other objects or operations.

Since at design time the final program is not available, the actual execution times of different objects may be of little importance. Rather the relative execution time required by various elements may be of significance. The relative execution time can be expresses in ordinal scale, in which only the relative order between sizes is important and not the differences therebetween, in interval scale in which the differences between the execution times may be ordered on an affine line, or the like.

Another type of comparative issues relates to accesses to shared memory areas. In such cases it may be required to assess the time each thread waits for the shared memory, relatively to the time the thread holds the access to the memory while other threads may be waiting. Such data can be used for example to enhance the scalability of the program, by designing the program such that increase in the number of threads does not affect the waiting time.

One technical solution is to integrate performance assessment capabilities into an Integrated Development Environment (IDE), in which the model is generated. Although the execution time of each operation is generally unknown at design time, the number or frequency of accesses to a particular object or method can be of great importance, and particularly the relative number or frequency between objects or methods. Thus, if the designer is aware of a particular object or method being invoked more often than others or for longer periods of time, it will be noted that such objects or methods should be programmed to be as efficient as possible, or the design should otherwise be changed to eliminate such problems. Such data can be obtained by automatically adding special instructions that set a counter for one or more design entities such as objects, methods, states, transitions, or the like, and increment the counter at each invocation of the entity. If no other information is available, the counter may be incremented by 1 at each such invocation.

Moreover, sometimes some relative estimate can be provided as to how resource-consuming is each operation is relatively to other operations, thus enabling some relative assessment of the time required by each entity, rather than just its invocation frequency.

For example, the code instructions of the model can be divided into several categories, such as but not limited to: retrieving data from persistent storage such as a disk, storing data in persistent storage, loading data from volatile storage such as a memory, storing data in volatile storage, arithmetic operations, branching, or the like. Each such category can be associated with relative estimated duration, so that comparative assessment can be provided. Even further, in some embodiments the estimated duration can reflect the actual average time on the target machine on which the program is intended to be executed, thus providing realistic estimates.

Another example of comparative performance issues that can be tested at design stage, relates to the ratio between the time a thread in a multi core environment waits for acquiring access to a shared resource such as a memory area, and the time the thread holds that access before releasing it.

Such information can be obtained by setting locks and counters at the beginning and end of each block of design code that accesses such memory areas. A lock protects the data by enabling for example only one thread to write into shared memory, enabling multiple threads to read into shared memory, or the like. In some exemplary embodiments, the lock may protect the data by limiting invocation of commands that access the data by a second thread, before a first thread has finished executing the commands. A counter on a lock can be implemented as so as to count the number of threads trying to obtain access to the code, to count the waiting time a particular thread is waiting for the lock in some units, called for example “ticks”, to count the time each thread actually holds the lock, or the like.

Regardless of how long a “tick” is in real units of time, such information can show phenomena such as whether the number of threads waiting to obtain a lock for a shared memory area at every given point in time is generally increasing, which makes the program non-scalable; whether the time a thread waits for access is much longer than the time the thread holds the access, which indicates that the program is highly inefficient, or the like.

These counters can be set by adding instrumentation instructions to design code such as UML state diagrams, object diagrams, or the like, wherein the instrumentation instructions are performed when the model is animated as part of its testing.

In some embodiments, some of the information can be displayed as one or more additional graphic layers displayed with a UML diagram. For example, the invocation frequency of a class, object, method, state, transition or another entity, or the processing time these entities consume relatively to other entities, can be indicated using a color-coded, width coded or pattern-coded line, frame, or filling of the graphical shape representing the entity. In other embodiments, the information can be presented textually, in a table, in a chart such as a histogram or a pie chart, or in any other manner.

One technical effect of utilizing the disclosed subject matter is provisioning the designer or developer with performance assessments, resource consumption data, possible bottlenecks, indications of inscalable code areas or the like, thus providing early alerts about possible problems so that the design can be fixed before significant resources are invested in programming, for example by enhancement of the IDE by instrumentation commands when animating the model.

Yet another technical effect of the disclosed subject matter relates to visually displaying performance data with the model. In general, a model may be displayed in a graphical manner, for example as one or more diagrams. However, performance data is usually not presented in a graphical manner that is closely related to the diagram, but rather uses a different set of tools. The disclosed subject matter thus provides for enhancing the graphic language of the model with performance indications.

In some exemplary embodiments, counters to all objects and all methods may be automatically created and incremented, in order to provide the full performance picture of the program. In other embodiments, the user may select which elements portions of the model the user wishes to view and compare, in order to focus on specific areas of interest.

In the specification, a designer, a developer, or the like are used interchangeably, and refer to a user defining the model, correcting the model, amending the model, enhancing the model, viewing the model or the like.

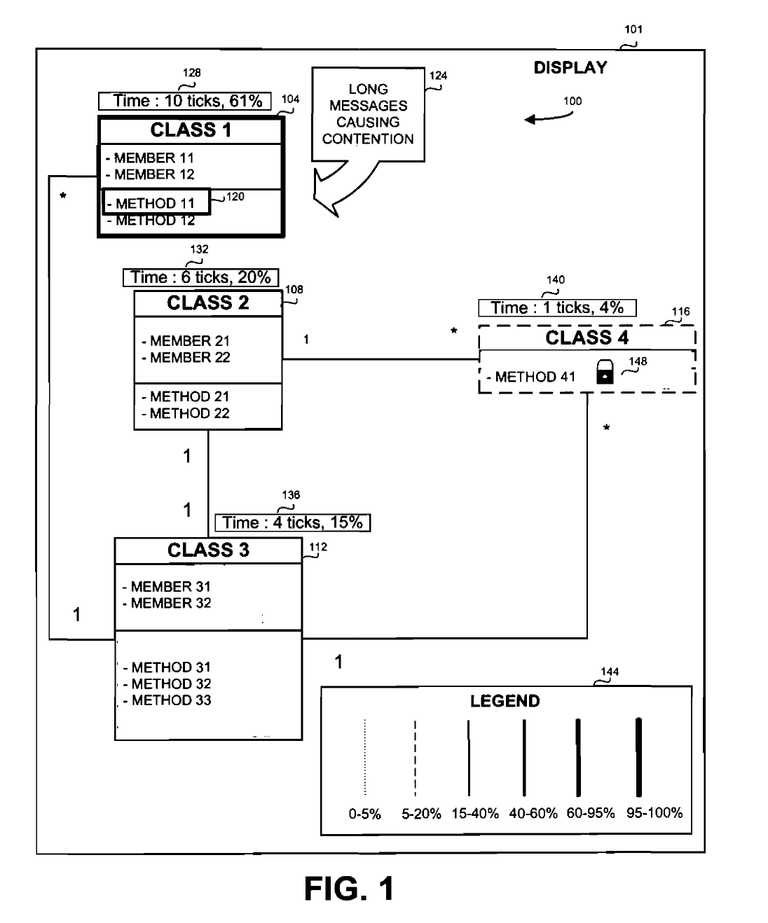

Referring now to FIG. 1, showing an exemplary class diagram with performance indications in accordance with the disclosure. The class diagram, generally referenced 100 is displayed on graphic display 101 and comprises class 1 (104), class 2 (108), class 3 (112) and class 4 (116), and links between some of the classes. In response to animation of the model with the performance assessment instrumentation code, the counters set for each class may indicate profiling information, and in particular the number of ticks or any other time unit, and the percentage of the overall execution time, consumed by the class. Thus, it may be indicated by caption 1 (128) that class 1 (104) was executed for 10 ticks, consisting of 60% of the total execution time, caption 2 (132) indicates that class 2 (108) was executed for 6 ticks, consisting of 20% of the total execution time, caption 3 (136) indicates that class 3 (112) was executed for 4 ticks, consisting of 15% of the total execution time, and caption 4 (140) indicates that class 4 (116) was executed for 1 tick, consisting of 4% of the total execution time. A class execution time may refer collectively to the total execution times of all invoked methods of the class.

The measurements, such as time consumption, and particularly the relative order between the time consumption of elements may also be visually indicated by any graphical means such as frame thickness, color, or pattern of one or more shapes representing the elements, or the like. In the exemplary illustration of FIG. 1, each class is surrounded by a frame indicating the range of percentage of time the class animation consumed, wherein the frame width or pattern and associated indication are detailed in legend 144.

Also indicated by a frame thicker than other frames is method 11 (120) of class 1 (104), indicating that execution of method 11 (120) took longer than other executions. It will be appreciated that a detailed caption can also be provided for any method, for methods having execution time or percentage exceeding a threshold, or the like.

It will also be appreciated that the provided captions can indicate the estimate for the actual time each class or method consumes, the invocation number or frequency of each object or method, or the like.

The graphic display on top of the UML diagram enables a developer to easily obtain insight of the time consumption ratios between the different parts of the design, and approve or correct the design accordingly.

In some embodiments, specific comments may be generated for particular entities, which draw the user's attention to particularly resource consuming entities, such as methods. For example, tooltip 124 is associated with method 11 (120) and provides a string indicating that processing long text messages within the method may cause contention.

Such messages can be generated, for example, based on identifying particular patterns within the model, similarly to the way compilation errors or warnings may be generated by a compiler, wherein the patterns are such that may have influence on performance issues.

Some embodiments of the disclosed method and apparatus may also provide for locks protecting access to shared data by multiple threads and monitoring performance. An exemplary embodiment comprises adding instrumentation code that sets a lock before a code fragment that accesses a shared resource such as a shared memory area, and releases the lock once the code has been executed. A thread can thus execute the code after obtaining a hold of the associated lock, which can be done after the lock has been released by another thread that previously held the lock. The time each thread waits for a lock can be measured in “ticks” or in actual time units, if such information is available.

A lock may be visually indicated, for example, as an icon displayed near a method that contains protected code or near a member of an object if access to the member is protected, or as any other indication associated with the protected code. In FIG. 1, a lock is indicated as icon 148 next to method 41 in class 4 (116). Visual properties of the lock may indicate its level, e.g., read, write or read and write, the execution of the protected code, or the like.

If, as described above, each instruction or instruction category is associated with relative or absolute duration, these durations can be accumulated while the model is being animated, to provide as exact as possible lock holding and waiting time assessments.

It will be appreciated that a lock can be associated with access levels such as read access, write access, or read and write access, and that in some embodiments multiple simultaneous read accesses can be granted, but write access, or read and write access can only be granted after a previous one was released.

It will be noted that FIG. 1 shows an exemplary class diagram. However, the disclosed subject matter may be similarly applied to other diagrams, such as for example a state machine diagram, an activity diagram, a component diagram, a deployment diagram, an object diagram, a communication diagram, other UML or non-UML diagrams, or the like.

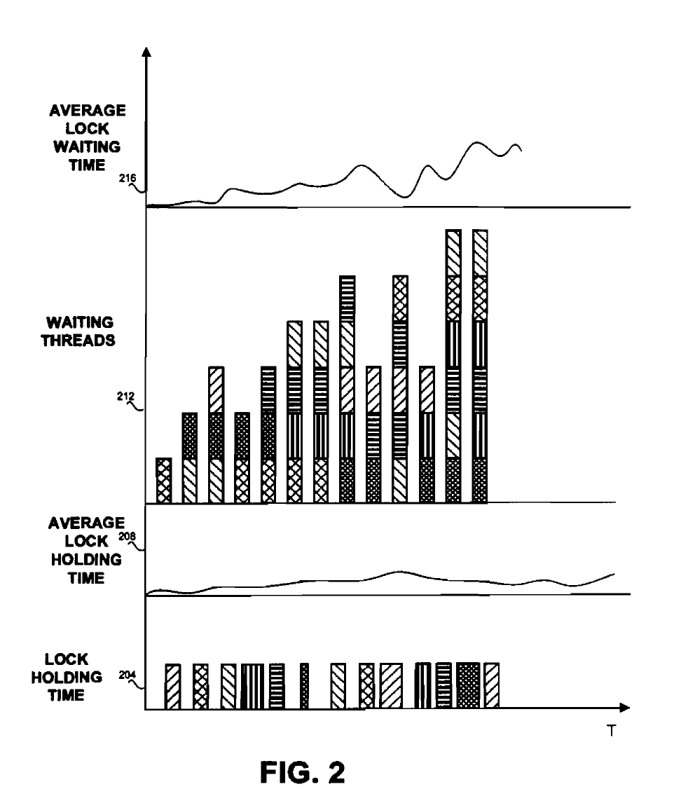

Referring now to FIG. 2, showing an exemplary illustration of data, such as trace data related to lock holding and waiting times, according to some exemplary embodiments of the disclosure.

FIG. 2 shows four graphs, each indicating an aspect of lock waiting and holding times, in association with a particular lock. FIG. 2 relates to exclusive access, such as a write lock but it will be appreciated that similar representations can be designed for other types of locks.

Lock holding time graph 204 shows the relative time each thread held the lock so that no other thread could access the data. The different patterns of the bars in graph 204 indicate different threads, and the width of each bar indicates the period of time the thread held the lock.

Graph 208 shows the average holding time of the lock at each point in time. It can be seen that exemplary graph 208 is slightly increasing at the beginning, but then stabilizes, which means that the lock holding duration did not change significantly over time.

Waiting threads graph 212 shows which threads are waiting for the lock at each point in time. In the example of FIG. 2, graph 212 is not necessarily associated with graph 204 and may not refer to the same timeline. Although the bars in graph 212 are drawn spaced apart, it will be appreciated that this is for clarity purposes, and that the spaces do not necessarily indicate that no thread was waiting at the respective time. It can be seen that the number of waiting threads is generally increasing, which is also seen in average lock waiting time graph 216, which indicates the average time a thread had to wait for the lock at a particular point in time.

Since the number of waiting threads generally increases, so does the average waiting time, which may indicate a problem of unscalability. For example, the example shown in FIG. 2 relates to six different threads whose waiting times are increasing, and if additional threads would be active and wait on the same locks, the situation will worsen. A developer presented with this performance data may realize that when the program operates for longer times, the program may reach states in which the waiting time is much longer than the functional time, or in other words the system may be congested.

In some exemplary embodiments, as shown in lock 148 of FIG. 1 detailed above, an icon shaped for example as a lock or a button can be displayed in a diagram such as a UML diagram, near a shape representing a method or function indicated by a user as containing access to shared resources, such that when a user points at the icon, one or more graphs similar to the graphs of FIG. 2 are displayed.

In some further embodiments, all portions of the model that access shared data may be traced, and an icon can be automatically displayed near the shape representing any method or function that contain such code. A user can thus have access to data related to all code areas that access shared memory in the system, without having to specifically indicate such areas.

In some exemplary embodiments, the user can make what-if simulation by indicating for each lock whether it is a read lock, a wrote lock, or a read-and-write lock, to see whether and how the resulting graphs are affected.

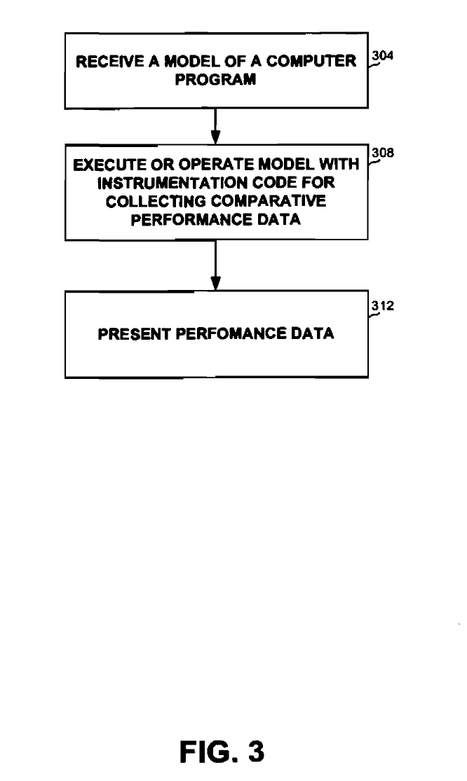

Referring now to FIG. 3, showing a flowchart of steps in a method for performance assessment of a computer program model.

On step 304 a model of a computer program is received by a program or system adapted for performing performance assessment. The model can be in any modeling language, such as UML or others. The model can comprise any one or more class diagrams, object diagrams, state diagrams, additional diagrams descriptive of an aspect of the computer program, or the like.

In some exemplary embodiments, the animation may be performed by an interpreter operative to further perform the additional monitoring or tracing operations. In some exemplary embodiments, the animation may be performed by generating a computer program based on the model and instrumenting the computer program with appropriate instructions. Alternatively, an enhanced computer program may be generated directly from the model. The animation may be performed by additional methods that are obvious to a person of ordinary skill in the art in view of the teachings of the present disclosure.

On step 308, the model is operated, sometime also referred to as executed or animated. Operating the model comprises performing operations defined by the model, so as to simulate execution of a computer program corresponding to the model (e.g., a computer program generated from the model, programmed based on the model or specification thereof, or the like). Operation of the model may be enhanced by instructions related to determining comparative performance assessment of one or more properties of the model, such as execution time of an entity, waiting time for a lock, or the like. The model enhancement may comprise instructions for implementing counters for particular entities, such as objects, methods, functions, states, transitions, code areas accessing shared variables, or the like.

Thus, the development environment is enhanced to provide additional data related to performance measurements, such as comparative measurements. Depending on the development environment, the counter instructions can be added prior to executing the model or on the fly.

In some embodiments, counters may count accesses, i.e., number of invocations of particular entities such as objects or methods, while other counters may accumulate execution or animation time in absolute or relative time terms, while yet other counters may count the number of threads trying to access code accessing a shared memory area.

In some embodiments the data is comparative, i.e., can show relative data rather than absolute times. Examples may include but are not limited to the percentage of processing time each entity consumes, the ratio between the time a thread is waiting for a lock and the time it holds the lock, the change over time of the average duration a tread is waiting for a lock, or the like.

On optional step 312, some or all of the accumulated data is presented to a user. Some data, for example data that relates to objects that have graphic representation as part of the model, for example classes appearing on a UML class diagram, can be displayed graphically by indicating the data on the class diagram, for example by adding an indicative frame around the element, using a different color, pattern or frame for the shape representing the element, or the like.

Other representations may include for example graphic representation independent of the model diagram, such as a histogram for the processing time consumption of multiple elements, changes in one or more performance parameters over time, textual representation, table representation, storing data in a database, or others.

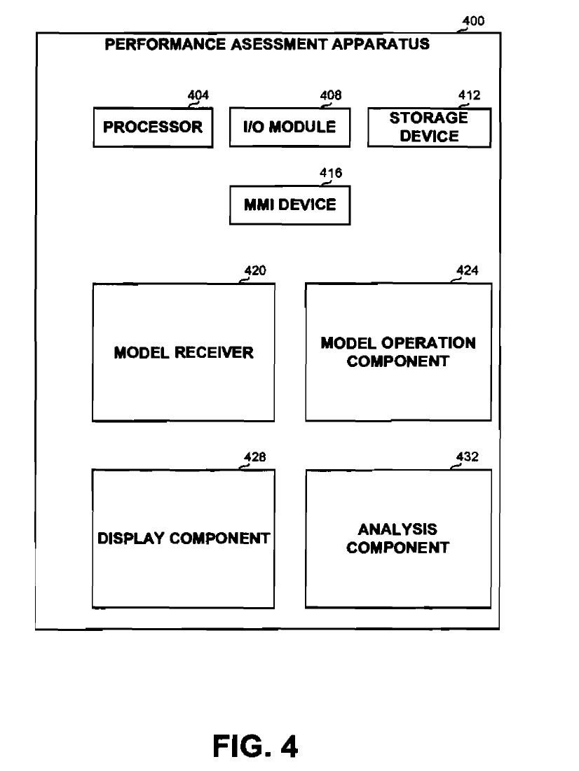

Referring now to FIG. 4 showing a computerized apparatus 400 in accordance with some exemplary embodiments of the disclosed subject matter, the apparatus operative for determining performance assessment of a model.

In some exemplary embodiments, apparatus 400 may comprise a processor 404. Processor 404 may be a Central Processing Unit (CPU), a microprocessor, an electronic circuit, an Integrated Circuit (IC) or the like. Alternatively, apparatus 400 can be implemented as firmware ported for a specific processor such as digital signal processor (DSP) or microcontrollers, or can be implemented as hardware or configurable hardware such as field programmable gate array (FPGA) or application specific integrated circuit (ASIC). Processor 404 may be utilized to perform computations required by apparatus 400 or any of it subcomponents.

In some exemplary embodiments of the disclosed subject matter, apparatus 400 may comprise an Input/Output (I/O) module 408. I/O module 408 may be utilized to receive input or provide output to and from the apparatus, for example receiving specific user commands or parameters related to the apparatus, providing output for viewing performance data, problem indications, bottlenecks, or the like.

In some exemplary embodiments, apparatus 400 may comprise one or more storage devices such as storage device 412. Storage device 412 may be persistent or volatile. For example, storage device 412 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 412 may retain program code operative to cause processor 404 to perform acts associated with any of the steps of method 300, for example storing the model or the performance data.

A user (not shown) may utilize a man-machine interface (MMI) device 416 such as a terminal, a display, a keyboard, an input device or the like to interact with the system, to invoke the system and to receive results. It will however be appreciated that the system can operate without human operation.

The components detailed below may be implemented as one or more sets of interrelated computer instructions, executed for example by processor 404 or by another processor. The components may be arranged as one or more executable files, dynamic libraries, static libraries, methods, functions, services, or the like, programmed in any programming language and under any computing environment.

Apparatus 400 may comprise a model receiver 420, for receiving a model or part thereof, such as one or more UML diagrams describing a computer program. Each such model or part thereof represents one or more aspects of the computer program, such as associated classes, objects, states, or the like.

Apparatus 400 may further comprise model operation component 424 for animating the model received by model receiver 420, and determining comparative performance assessment of a property of the model. The properties may relate to percentage of the animation time consumed by one or more objects, states or other entities, waiting and hold durations of locks protecting code areas that access shared memory areas, or the like.

Model operation or animation component 424 may be operatively coupled to a code enhancement component (not shown) for enhancing the model with instructions related to counters or locks, including for example defining the counters, incrementing the counters, or the like. In some embodiments, the enhancement component can also identify code fragments within the model that access memory areas shared between different threads, and automatically add locks to such areas. This functionality may also be provided by analysis component 432 detailed below.

Apparatus 400 optionally comprises display component 428 which provides display of the information gathered during animation. Some display options may be associated with diagrams of the received model, such as UML diagrams, wherein the display presents properties of parts of the model in a graphic manner Other display manners can include textual display, table-based display, graph-based display wherein the graph is not part of the model, or others.

Yet another component which may be comprised within apparatus 400 is analysis component 432, which is responsible for further analysis associated with the performance assessment, such as identifying code areas accessing shared memory variables, performing advanced statistics and analysis on the gathered data, performing what-if analysis in regard to lock levels, or the like.

The disclosed method and apparatus add functionality to IDEs by providing the ability to obtain performance measurements of entities of a model, and present them. It will be appreciated that the method and apparatus can be implemented as part of an IDE, as an add-on, as a separate module, or the like.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
receiving a model describing an aspect of a computer program; and
operating the model, and determining comparative performance assessment of a property of the model.

2. The computer-implemented method of claim 1, further comprising displaying the comparative performance assessment.

3. The computer-implemented method of claim 1 wherein said operating comprises:
associating a first counter with a first element of the model, and associating a second counter with a second element of the model; and
incrementing a first value of the first counter in response to the first element being invoked, and incrementing a second value of the second counter in response to the second element being invoked.

4. The computer-implemented method of claim 3 further comprising displaying the comparative performance assessment wherein displaying is performed by at least one display mode selected from the group consisting of: displaying indications of the first value and the second value on a diagram associated with the model; displaying the first element and the second element in a manner demonstrating relative order between the first value and the second value; displaying the first value and the second value in a table; and displaying the first value and the second value in a textual manner

5. The computer-implemented method of claim 3, wherein the model is an object diagram and wherein each of the first element and the second element is selected from the group consisting of: a class, an object, a method, a model component, a part, an association and an operation.

6. The computer-implemented method of claim 3, wherein the model is a state diagram and wherein each of the first element and the second element is selected from the group consisting of: a state and a transition.

7. The computer-implemented method of claim 3 wherein the first value is incremented by 1 in response to the first element being invoked, and the second value is incremented by 1 in response to the second element being invoked.

8. The computer-implemented method of claim 3 wherein:
a first duration indication is associated with a first operation of the first element, and wherein the first value is incremented by the first duration indication in response to the first operation being invoked; and
a second duration indication is associated with a second operation of the second element, and wherein the second value is incremented by the second duration indication in response to the second operation being invoked.

9. The computer-implemented method of claim 1, further comprising associating a lock counter with a lock restricting access to a shared resource, the lock counter comprising information related to at least one item selected from the group consisting of: a number of threads waiting for the lock; an indication for a waiting duration each thread waits for the lock; an indication for a holding time duration each thread holds the lock; and relation between any two of the at least one item,
and the method further comprising incrementing the lock counter in response to an operation associated with the lock.

10. The computer-implemented method of claim 9 wherein the lock is associated with a lock level.

11. The computer-implemented method of claim 1, further comprising associating a string with an element of the model or the property of the model related to the comparative performance assessment of the model, and displaying the string.

12. An apparatus having a processing unit and a storage device, the apparatus comprising:
a computer program receiver configured to obtain a model describing an aspect of a computer program; and
an animation component for operating the model, and determining comparative performance assessment of a property of the model.

13. The apparatus of claim 12 further comprising a display component for displaying the comparative performance assessment.

14. The apparatus of claim 12 wherein said animation component is adapted to enhance the model by:
associating a first counter with a first element of the model, and associating a second counter with a second element of the model; and
incrementing a first value of the first counter in response to the first element being invoked, and incrementing a second value of the second counter in response to the second element being invoked.

15. The apparatus of claim 14 further comprising a display component for displaying the comparative performance assessment, wherein the display component is adapted to output a display selected from the group consisting of:
display indications of the first value and the second value on a diagram associated with the model; displaying the first element and the second element in a manner demonstrating relative order between the first value and the second value; displaying the first value and the second value in a table; and displaying the first value and the second value in a textual manner

16. The apparatus of claim 14 wherein the model is an object diagram and wherein each of the first element and the second element is selected from the group consisting of: an object, a method, a model component, a part, an association, and an operation.

17. The apparatus of claim 14 wherein the model is a state diagram and wherein each of the first element and the second element is selected from the group consisting of: a state and a transition.

18. The apparatus of claim 12 wherein said animation component is adapted to associate a lock counter with a lock restricting access to a shared resource, the lock counter comprising information related to at least one item selected from the group consisting of: a number of threads waiting for the lock counter; an indication for a waiting duration each thread waits for the lock; and an indication for a holding time duration each thread holds the lock counter,
and wherein said animation component is further adapted to enhance the model by incrementing the lock counter in response to an operation by the model associated with the lock.

19. The apparatus of claim 18 wherein the lock counter is associated with a lock level.

20. The apparatus of claim 12 further comprising an analysis component adapted to analyze data obtained by the animation component.

21. A computer program product comprising:
a non-transitory computer readable medium;
a first program instruction for receiving a model describing an aspect of a computer program; and
a second program instruction for operating the model, and determining comparative performance assessment of a property of the model,
wherein said first and second program instructions are stored on said non-transitory computer readable medium.
